(19) United States
(12) Patent Application Publication
(10) Pub. No.: US 2004/0108475 A1
(43) Pub. Date: Jun. 10, 2004

(54) Sensor device

(76) Inventors: Thomas Niemann, Delmenhorst (DE); Carsten Heilenkoetter, Weyhe (DE); Thomas Henke, Beverstedt (DE)

Correspondence Address: BIRCH STEWART KOLASCH & BIRCH, PO BOX 747, FALLS CHURCH, VA, 22040-0747, US

(21) Appl. No.: 10/724,899

(22) Filed: Dec. 2, 2003

(30) Foreign Application Priority Data
Dec. 3, 2002 (DE) 102 56 645.3

(51) Int. Cl. G01V 8/00; G01N 21/86

(52) U.S. Cl. 250/559.04

(57) ABSTRACT

A sensor device for determining the intensity of incident light is provided. The sensor device includes a characteristic element, through which light striking the sensor device can pass depending on the direction from which light strikes the sensor device; a light-sensitive sensor element, which can detect the light having passed through the orientation characteristic element; and an absorption element, which can absorb the light striking the sensor device and/or the light having passed through the orientation characteristic element in such a way that the amount of light striking the light-sensitive sensor element does not exceed a predetermined value, whereby the absorption element is a reflective surface.

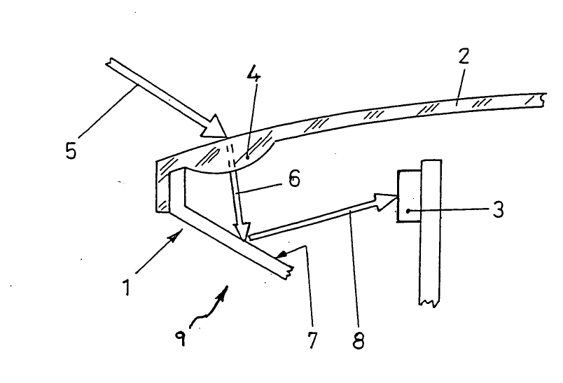

This nonprovisional application claims priority under 35 U.S.C. § 119(a) on Patent Application No. 102 56 645.3 filed in Germany on Dec. 3, 2002, which is herein incorporated by reference.

### BACKGROUND OF THE INVENTION

1. Field of the Invention

The present invention relates to a sensor device for determining the intensity of incident light radiation depending on the angle of incidence, in particular for determining sun irradiation to a motor vehicle. The sensor device includes at least one orientation characteristic element through which the light striking the sensor device, depending on the angle of incidence, can pass; at least one light-sensitive sensor element, which is able to detect the light having passed through the orientation characteristic element; and at least one absorption element, which is able to absorb the light striking the sensor device and/or the light having passed through the orientation characteristic element in such a way that the light power striking the light-sensitive sensor element does not exceed a preset value.

2. Description of the Background Art

A sensor device is known from European Patent EP 0 350 866 B1. The sensor device described therein is specifically used as a sun sensor for a motor vehicle, whereby the sun sensor modulates, for example, an automatic heating/cooling system that has different settings for various temperature zones. Temperatures in direct sunlight are subjectively perceived differently, so that it makes sense to select a different temperature setting when exposed to direct sunlight, particularly, to turn the temperature setting down somewhat. The orientation characteristic element of the conventional sensor device is formed as a cover on a housing, in which the sensor element is located. The cover has a variation in thickness, so that at different points, depending on the incidence angle of the light striking the sensor device, a varying amount of light is transmitted to the housing interior.

In the conventional sensor device, this angle-dependent effect can be increased by varying the absorption at different points of the cover. Additionally, the cover also serves as an absorber, whereby an absorber is especially beneficial for conventional sensor devices, because, as a rule, the very light-sensitive sensor element tends to exhibit an overmodulated output signal when a certain incident light strength is reached.

The disadvantage of the conventional sensor device is that the cover has a dual function, namely, as an orientation characteristic element as well as an absorber. In this way, the cover cannot be flexibly adapted to local conditions, that is, it cannot be optimized for both purposes. Furthermore, as a rule, the actual design of the cover should be considered, which in the conventional sensor device would be very difficult because of the dual function of the cover.

### SUMMARY OF THE INVENTION

It is therefore an object of the present invention to provide a more flexible sensor device. This is achieved by providing an absorption element that is formed as a reflecting surface. By developing an absorption element that serves as an additional reflecting surface, the designs of the orientation characteristic element and the absorption element are separate from one another so that both can be optimized.

In an advantageous embodiment, the reflecting surface can be arranged in such a way that the light having passed through the orientation characteristic element can be reflected by the reflecting surface, whereby the reflected light can be, at least partially, detected by the sensor element. Thus, the reflecting surface is, with respect to the orientation of the light to be detected, arranged behind the orientation characteristic element, so that the incident light having received the desired orientation characteristic is absorbed in such a way that overexposure of the sensor element to light does not occur.

In a further embodiment of this invention, the reflecting surface can have a shape, a coarseness, and/or a reflectivity in order to achieve the desired absorption of the light striking the reflecting surface. Since the absorption function is separate from the orientation characteristic function, the reflecting surface can be designed in such a way using any appropriate measure so that the desired absorption, that is, the desired reflectivity, can be achieved.

According to the present invention, a sensor device includes a housing and a housing cover, which covers at least part of the housing. The sensor element may be located on the inside of the housing, which allows a stylish design of the cover.

In a preferred embodiment of the present invention, the orientation characteristic element is located on or in the cover. Furthermore, the reflecting surface can be located inside the housing or on a partial surface thereof. Thus, the cover and the reflecting surface are separate parts and, as such, can be optimized and designed separately from one another.

In particular, the orientation characteristic element can be an optic formed on the cover to divert the light striking the sensor device at least partially to the reflecting surface. This allows, for example, that the formed optic can be a curvature, a lens, and/or a Fresnel lens. The formed optic can be, for example, arranged on the inside of the cover in such a way that the top shape of the cover can be designed independently from the optic. Thereby, the optic can be designed in such a way that the desired angle-dependent orientation characteristic resulting from the optic can be achieved.

In a further embodiment, the sensor element is an infrared-sensitive sensor element. As such, the cover can be impenetrable to visible light, so that the comparatively unattractive interior of the housing is not visible to the user.

As an alternative, the sensor element can be designed to be sensitive to the visible region, or to both the visible region and the infrared region.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the FIGURE is a schematic illustration of a cross-sectional view of a sensor device according to a preferred embodiment of the present invention.

### DETAILED DESCRIPTION OF THE PREFERRED EMBODIMENTS

Referring to the drawing, there is illustrated a sensor device 9 having a housing 1 with an upper cover 2. In addition, there is a light-sensitive sensor element 3 provided inside the housing 1.

A part of the cover 2 is designed as an orientation characteristic element 4, which allows at least part of the light 5 striking the sensor device 9 to pass through the housing 1. The beam path of the incident light 5 and the light 6 having passed through the orientation characteristic element 4 are illustrated merely schematically. The orientation characteristic element 4 can be shaped in such a way that, depending on the direction of the light 5 striking the orientation characteristic element 4, more or less light 6 passes through the orientation characteristic element 4. This can be realized, for example, by varying the degree of absorption of the orientation characteristic element 4 in individual differing directions. It is also possible to design the orientation characteristic element 4 as an attachment to the underside of the cover 2, as indicated in the drawing. By using such an attachment serving as an optic, partial radiation of light 5 striking the orientation characteristic element 4 from varying angles can be transmitted at varying intensities, that is, they can be partially reflected at varying intensity so that they contribute at varying degrees to the passed-through light 6, depending on their angle of incidence. The attachment can be, for example, a curvature, a lens, or a Fresnel lens.

Furthermore, the sensor device 9 of the present invention includes a reflecting surface 7 located at the inside of housing 1 and serves as an absorption element. Light 6 having passed through the orientation characteristic element 4 strikes the reflecting surface 7 and is diverted towards the sensor element 3 by the reflecting surface 7. By using a specialized design of the reflecting surface 7, it is possible to predetermine, from the light 6 that strikes the reflecting surface 7, the amount of reflected light 8 that strikes the sensor element 3. For example, via the shape, the coarseness, and the reflectivity, that is, the degree of glare of the reflecting surface 7, the degree of reflectivity, that is, the absorption of light 6, can be controlled by the reflecting surface 7.

The sensor element 3 can be a sensor element that is sensitive to infrared light. Therefore, the orientation characteristic element 4 for infrared light can be optimized. Consequently, the reflecting surface 7 should be designed for infrared light in regards to its reflectivity and/or its absorption, which can be preferably detected by the sensor element 3.

Alternatively, it is possible to design the sensor element 3 to be sensitive to the visible region or for both the visible region and the infrared region. Accordingly, the orientation characteristic element 4 and reflective surface 7 can be optimized, for example, for parts of the visible region of the spectrum.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A sensor device for determining the intensity of incident light depending on the direction of the light, the sensor device comprising:
at least one orientation characteristic element, through which the light striking the sensor device, depending on the angle of incidence, can pass;
at least one light-sensitive sensor element, which can detect the light that passed through the orientation characteristic element; and
at least one absorption element, which is able to absorb the light striking the sensor device and/or the light having passed through the orientation characteristic element in such a way that the light power striking the light-sensitive sensor element does not exceed a predetermined value,
wherein the absorption element is formed as a reflecting surface.

2. The sensor device according to claim 1, wherein the reflecting surface is arranged in such a way that the light having passed through the orientation characteristic element can be reflected by the reflecting surface, wherein a portion of the reflected light can be detected by the sensor element.

3. The sensor device according to claim 1, wherein the reflecting surface has a shape, a coarseness, and/or a reflectivity in order to achieve a desired absorption of the light striking the reflecting surface.

4. The sensor device according to claim 1, wherein the sensor device has a housing, and wherein the housing has at least a partial cover.

5. The sensor device according to claim 4, wherein the orientation characteristic element is located on or in the cover.

6. The sensor device according to claim 4, wherein the reflecting surface is located inside the housing on a partial surface of the housing.

7. The sensor device according to claim 5, wherein the orientation characteristic element is an optic that is molded to the cover, through which the light striking the sensor device is at least partially diverted to the reflecting surface.

8. The sensor device according to claim 7, wherein the molded optic is a curvature, a lens, and/or a Fresnel lens.

9. The sensor device according to claim 1, wherein the sensor element is an infrared-sensitive sensor element.

10. The sensor device according to claim 1, wherein the sensor element detects light in the visible region.

11. The sensor device according to claim 1, wherein the sensor element detects light in the infrared region.

12. The sensor device according to claim 1, wherein the sensor element detects light in the visible region and the infrared region.

13. The sensor device according to claim 1, wherein the sensor device is for a motor vehicle.

14. The sensor device according to claim 1, wherein the sensor device provides an output to control a heating and cooling system.

15. A light sensor comprising:
a housing;
an orientation characteristic element for enabling a predetermined amount of light radiation to pass there through, the orientation characteristic element being provided on the housing; and
a reflecting surface for receiving the predetermined amount of light radiation passed through the orientation characteristic element, the reflecting surface directing at least a portion of the predetermined amount of light towards a sensor element, which detects the at least a portion of the predetermined amount of light.

16. The light sensor according to claim 15, wherein the orientation characteristic element directs the predetermine amount of light radiation towards the reflecting surface.

17. The light sensor according to claim 15, wherein the at least a portion of the predetermined amount of light directed towards the sensor element by the reflecting surface has a value being less than a predetermined threshold.
